(19) United States
(12) Patent Application Publication
(10) Pub. No.: US 2005/0143209 A1
(43) Pub. Date: Jun. 30, 2005

(54) Friction drive belt and method for fabricating the same

(75) Inventor: Tomoya Shibutani, Hyogo (JP)

Correspondence Address: NIXON PEABODY, LLP, 401 9TH STREET, NW, SUITE 900, WASHINGTON, DC, 20004-2128, US

(73) Assignee: BANDO CHEMICAL INDUSTRIES, LTD., Kobe-shi (JP)

(21) Appl. No.: 10/923,839

(22) Filed: Aug. 24, 2004

(30) Foreign Application Priority Data
Aug. 25, 2003 (JP) 2003-299737

(51) Int. Cl. F16H 7/12; F16G 5/00

(52) U.S. Cl. 474/260; 474/137; 474/264

(57) ABSTRACT

A friction drive belt is used by being wrapped around a plurality of pulleys and transmits power by friction between its belt body and each of the pulleys. The working part of the belt body has a structure in which rubber layers and non-woven fabric layers are alternately stacked along the thickness of the belt.

### CROSS REFERENCE TO RELATED APPLICATIONS

This non-provisional application claims priority under 35 U.S.C. § 119(a) on Patent Application No. 2003-299737 filed in Japan on Aug. 25, 2003, the entire contents of which are hereby incorporated by reference.

### BACKGROUND OF THE INVENTION

(a) Field of the Invention

This invention relates to friction drive belts and methods for fabricating the same.

(b) Description of the Related Art

V-ribbed belts are generally used as automotive engine accessory drive belts. V-ribbed belts have a belt body made of rubber, of which a ribbed rubber layer (working part) contacting with a pulley contains short fibers oriented along the width of the belt. Furthermore, the short fibers contained in the belt body project beyond the belt surface. This reduces the friction resistance of the belt surface, leading to reduction of abnormal sounds produced between the belt and the pulley and reduction of abrasion at the belt surface.

Japanese Unexamined Utility Model Publication No. 6-40497 discloses a V-ribbed belt having a double-layered, ribbed rubber in which short fibers embedded into a rib top-side portion are oriented substantially along the length of the belt and short fibers embedded into the remaining rib root-side portion are oriented substantially orthogonally to the length direction of the belt. The document describes that when the belt is wrapped around a flat pulley in order to use it as a flat belt, an unpleasant stick-slip sound can be prevented from being produced in the belt travel.

Japanese Unexamined Patent Publication No. 7-63242 discloses a V-ribbed belt comprising a ribbed rubber layer formed of hydrogenated acrylonitrile-butadiene rubber (H-NBR), a tension member layer adjoining the ribbed rubber layer, and a top fabric layer adjoining the tension member layer, wherein part of the H-NBR rubber forming each rib root of the ribbed rubber layer is compounded with short fibers oriented substantially along the width of the belt, and part of the H-NBR rubber forming each rib top of the ribbed rubber layer is compounded with unsaturated carboxylic acid's metal salt. This document describes that the V-ribbed belt has excellent heat resistance, abrasion resistance and flex fatigue resistance even when used under severe conditions such as increasing atmospheric temperature, is free from troubles such as abrasion-induced failures, and therefore has a long life.

Japanese Examined Utility Model Publication No. 7-29330 discloses a V-belt for power transmission in which an adhesion rubber layer contains short fibers oriented along the belt width, a tension member layer is formed of a tension cord embedded in the adhesion rubber layer, a tension layer is laid on the tension member layer, and a compression rubber layer is laid under the tension rubber layer. Furthermore, a cord fabric is embedded in the rubber forming the compression rubber layer, a reinforcing rubber layer is formed, between the tension member layer and the cord fabric, with short fibers of the same type as in the adhesion rubber layer mixed thereinto in an orientation along the belt width and in higher volume per unit rubber weight than that of the short fibers in the adhesion rubber layer. The document describes: that the existence of the reinforcing rubber layer prevents the cord fabric from causing their abnormal approach to the tension cord and their disordering in embedded arrangement during the vulcanization of the belt, and absorbs the difference in the resistance against a lateral force from extremely sideward between the tension member layer and the cord fabric during the belt travel; and that since the reinforcing rubber layer exists to have a definite hardness difference from the adhesion rubber layer by intentionally increasing the amount of short fibers therein over that in the adhesion rubber layer, this contributes to avoidance of direct contact between the tension cord and the transversely parallel-arranged cords and suppresses the occurrence of delamination therebetween and, in the worst case, protrusion of the tension cord, resulting in enhanced belt durability.

Japanese Unexamined Patent Publication No. 10-338377 discloses an endless conveyer belt having a belt body formed of an elastic material and short fibers dispersed into the elastic material, wherein the short fibers have a length of 1 mm to 10 mm and a fineness of 0.5 denier to 30 denier, are mixed into the elastic material at a weight % of 1 to 30, and are dispersed into the whole belt body in an orientation along the belt length. The document describes that the belt is relatively thin and relatively high in coefficient of friction at its one side.

Japanese Unexamined Patent Publication No. 2001-146942 discloses a drive belt in which a cord is embedded along the belt length into an adhesion rubber layer, a cover fabric is stacked on the surface of the adhesion rubber layer, a compression rubber layer is disposed adjacent the adhesion rubber layer, and the compression rubber layer is formed so that at least one particle-dispersed rubber layer composed of rubber containing dispersed particulate inorganic material is interbedded in a short-fiber-mixed rubber layer composed of rubber containing dispersed short fibers. The document describes that since the drive belt includes the particle-dispersed rubber layer capable of keeping high the thicknesswise surface roughness of the belt working flank contacting with a pulley, it can exhibit high power transmission performance even with water on the working flank, has enhanced running life in a high temperature atmosphere and in a low temperature atmosphere, and is excellent in weather resistance.

Japanese Unexamined Patent Publication No. 2001-317595 discloses a drive belt having a V-rib provided along the belt length, wherein a plurality of rubber layers composed of those of rubber type compounded with short fibers and those of rubber type compounded with no short fiber are stacked, and the V-rib is formed of a combination of stacking of both types of rubber layers to control the coefficient of friction of the belt side ace. The document describes that various kinds of V-ribs can be produced using multiple levels of coefficients of friction without the need for design change in composition of the rubber compound for the V-rib.

Meanwhile, a V-ribbed belt is fabricated by wrapping around a molding drum materials including an unvulcanized rubber sheet, a woven fabric and a cord and then applying heat and pressure to the wrapped materials. In this case, used as the unvulcanized rubber sheet forming a ribbed rubber layer of the belt body is one containing short fibers oriented substantially perpendicularly to the direction of wrapping around the molding drum.

Such an unvulcanized rubber sheet as containing short fibers oriented in a single direction is produced by extending an unvulcanized rubber mass containing short fibers in the form of a sheet by a calender roll or other means. The unvulcanized rubber sheet thus produced contains short fibers oriented in the longitudinal direction of the sheet.

Therefore, in fabricating a V-ribbed belt, the elongate, short-fiber-containing, unvulcanized rubber sheet cannot be used as it is with its lengthwise direction aligned with the direction of wrapping around the molding drum, but needs to be cut in a slightly shorter length than the axial length of the drum and used as wrapped around the molding drum to align both the cut ends with both ends of the molding drum.

### SUMMARY OF THE INVENTION

An object of the present invention is to provide a friction drive belt having a novel construction that uses no short fiber-containing rubber, and a method for fabricating the same.

The present invention is directed to a friction drive belt, used by being wrapped around a plurality of pulleys, for transmitting power by friction between its belt body and each of the pulleys. In the friction drive belt, a working part of the belt body through which power is transmitted has a structure in which one or more rubber layers and one or more non-woven fabric layers are alternately stacked along the thickness of the belt.

According to the friction drive belt having the above structure, the non-woven fabric layer or layers exposed at the belt surface reduce the friction resistance at the belt surface, and therefore suppress abnormal sounds produced between the belt surface and the pulley and friction at the belt surface. That is, the friction drive belt of this invention has the same belt performance as a friction drive belt in which the working part of its belt body is formed of short-fiber-containing rubber.

The non-woven fabric layer or layers of the working part preferably have a total thickness of 15% to 75%, both inclusive, of the thickness of the working part.

When the total thickness of the non-woven fabric layer or layers is 15% to 75%, both inclusive, of the thickness of the working part, the belt can play a fundamental role of power transmission and effectively reduce the coefficient of friction at the belt surface. More specifically, as described later with reference to Examples, if the total thickness of non-woven fabric layers is less than 15% of the thickness of the working part, abrasion at the belt surface during travel is significantly increased. On the other hand, if the total thickness of non-woven fabric layers is more than 75% of the thickness of the working part, the belt flex resistance is extremely deteriorated.

A friction drive belt of the present invention as described above can be fabricated by forming, on the outer periphery of a molding drum, a structure in which one or more unvulcanized rubber layers and one or more non-woven fabric layers are alternately stacked to cover the whole circumference of the molding drum; and applying heat and pressure to the layered structure of the unvulcanized rubber layer or layers and the non-woven fabric layer or layers to provide an integral lamination. Therefore, there is no need to cut a short-fiber-containing unvulcanized rubber sheet in an appropriate length and align the orientation of short fibers with the belt widthwise direction, unlike the case of fabricating a friction drive belt in which the working part of its belt body is made from short-fiber-containing rubber.

The types of friction drive belts according to the present invention are not particularly limited, but include friction drive belts in which the belt body is that of a raw edge plane V-belt, that of a raw edge laminated V-belt, that of a raw edge cogged V-belt, or that of a V-ribbed belt. V-ribbed belts are generally used for automotive accessory drive and produced much more than the other types of belts. Therefore, when the friction drive belt of the present invention is a V-ribbed belt, general belt productivity growth can be best achieved.

Other objects, features and benefits will be apparent from the following description referring to the accompanying drawings.

### BRIEF DESCRIPTION OF THE DRAWINGS

FIG. 1 is a perspective view showing a V-ribbed belt according to an embodiment of the present invention.

FIGS. 2A and 2B are diagrams illustrating a method for fabricating a V-ribbed belt.

FIG. 3 is a diagram illustrating the layout of a serpentine accessory drive system in which a V-ribbed belt is wrapped around pulleys.

FIGS. 4A to 4K are cross-sectional views showing various modifications of the inventive V-ribbed belt.

FIG. 5 illustrates a belt coefficient-of-friction measurement tester used for measuring the coefficient of friction at the ribbed rubber layer surface.

FIG. 6 is a diagram illustrating the layout of a belt run tester for evaluating V-ribbed belts based on an abrasion resistance test.

FIG. 7 is a diagram illustrating the layout of a belt run tester for running durability evaluation on V-ribbed belts.

FIG. 8 is a diagram illustrating the layout of a belt run tester for noiselessness evaluation on V-ribbed belts.

FIGS. 9A and 9B are graphs showing the relation between the total thickness of non-woven fabric layers and coefficient of friction.

FIGS. 10A and 10B are graphs showing the relation between the total thickness of non-woven fabric layers and rate of abrasion.

FIGS. 11A and 11B are graphs showing the relation between the total thickness of non-woven fabric layers and durability.

FIGS. 12A and 12B are graphs showing the relation between the total thickness of non-woven fabric layers and noiselessness.

FIG. 13 is a table showing belt structures and test evaluation results.

### DESCRIPTION OF THE PREFERRED EMBODIMENTS

Hereinafter, an embodiment of the present invention will be described in detail with reference to the drawings.

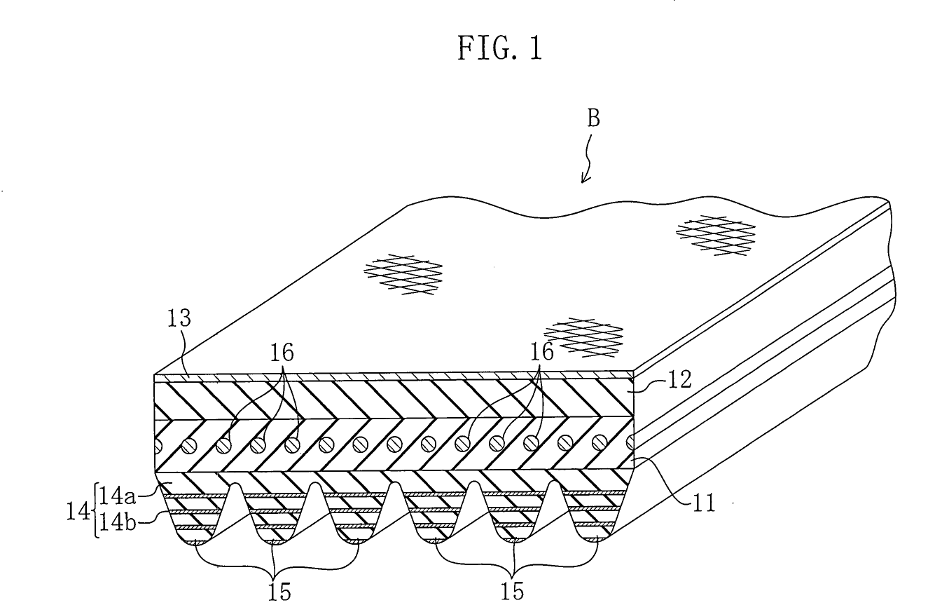

FIG. 1 shows a V-ribbed belt B according to an embodiment of the present invention.

The V-ribbed belt B is composed of an adhesion rubber layer 11, a tension rubber layer 12 provided integrally on the upper face of the adhesion rubber layer 11, a back face reinforcing fabric 13 attached integrally to the upper face of the tension rubber layer 12, i.e., provided on the belt back face side thereof, a ribbed rubber layer 14 provided integrally on the lower face of the adhesion rubber layer 11, i.e., on the belt inner face side thereof, a cord 16 disposed to form helical turns extending substantially along the length of the belt in the middle of the thickness of the adhesion rubber layer 11 and spaced at regular intervals in the belt widthwise direction. Among these members, the adhesion rubber layer 11, the tension rubber layer 12 and the ribbed rubber layer 14 constitute a V-ribbed belt body.

The adhesion rubber layer 11 forms a flat looped strip located in the middle of the V-ribbed belt body to extend along the length of the belt, is made from a rubber composition containing a rubber component such as chloroprene rubber (CR), ethylene-propylene-diene monomer (EPDM) or hydrogenated acrylonitrile-butadiene rubber (H-NBR), and serves as a layer for retaining the cord.

The tension rubber layer 12 forms a flat looped strip located on the adhesion rubber layer 11 in the V-ribbed belt body to extend along the length of the belt, and is made from a rubber composition containing a rubber component such as chloroprene rubber (CR), ethylene-propylene-diene monomer (EPDM) or hydrogenated acrylonitrile-butadiene rubber (H-NBR).

The back face reinforcing fabric 13 is formed by subjecting a woven fabric of warps and wefts made from nylon fibers, cotton or the like to adhesion treatment with rubber cement obtained by solving rubber in a solvent, and constitutes a reinforcing member for reinforcing the belt back face.

The ribbed rubber layer 14 is a portion of the V-ribbed belt body in which six ribs 15 are disposed, under the adhesion rubber layer 11, at regular pitches in the belt widthwise direction to extend along the length of the belt. The ribbed rubber layer 14 has a structure in which rubber layers 14a and non-woven fabric layers 14b are alternately stacked, and constitutes a working part for transmitting power to a pulley by directly contact with it. Each rubber layer 14a forming the ribbed rubber layer 14 is made from a rubber composition containing a rubber component such as chloroprene rubber (CR), ethylene-propylene-diene monomer (EPDM) or hydrogenated acrylonitrile-butadiene rubber (H-NBR), like the adhesion rubber layer 11. The rubber composition forming the rubber layer 14a may contain short fibers. The non-woven fabric layer 14b is formed by subjecting, prior to the molding of a belt, a sheet of non-woven fabric made of chemical fibers such as nylon fibers, polyester fibers or aramid fibers, or natural fibers such as cotton to adhesion treatment with, for example, resorcinol-formaldehyde latex (RFL) liquid or rubber cement. The proportion of non-woven fabric layers 14b that is contained in the ribbed rubber layer 14 is greater toward the belt inner periphery than toward the belt outer periphery, and the rib top is constituted by a non-woven fabric layer 14b. The total thickness of the non-woven fabric layers 14b is 15% to 75%, both inclusive, of the thickness of the ribbed rubber layer 14, i.e., the rib height.

The cord 16 is formed by subjecting, prior to the molding of a belt, a twist yarn (Z-twisted) made of polyethylene terephthalate (PET) fibers, polyethylene naphthalate (PEN) fibers or polyvinyl alcohol (PVA) fibers to adhesion treatment with resorcinol-formaldehyde latex (RFL) liquid or the like and stretch thermoforming process, and constitutes a tension member that gives strength and tensile strength to the belt.

According to the V-ribbed belt B having the above structure, the non-woven fabric layers 14b of the ribbed rubber layer 14 reduce the friction resistance at the belt surface, and therefore suppress abnormal sounds produced between the belt surface and the pulley and friction at the belt surface. That is, the V-ribbed belt B has the same belt performance as a V-ribbed belt in which a ribbed rubber layer serving as a working part is formed of short-fiber-containing rubber.

The shearing force acting on the belt becomes larger, in the working part, toward the belt outer periphery than toward the belt inner periphery. Therefore, if the proportion of non-woven fabric layers 14b contained in the ribbed rubber layer 14 becomes greater toward the belt outer periphery, the risk of delamination is increased. Since in this embodiment, however, the proportion of non-woven fabric layers 14b contained in the ribbed rubber layer 14 is greater toward the belt inner periphery than toward the belt outer periphery, delamination is less likely to occur.

Furthermore, since the total thickness of the non-woven fabric layers 14b is 15% to 75%, both inclusive, of the thickness of the ribbed rubber layer 14, the belt can play a fundamental role of power transmission and effectively reduce the coefficient of friction at the belt surface.

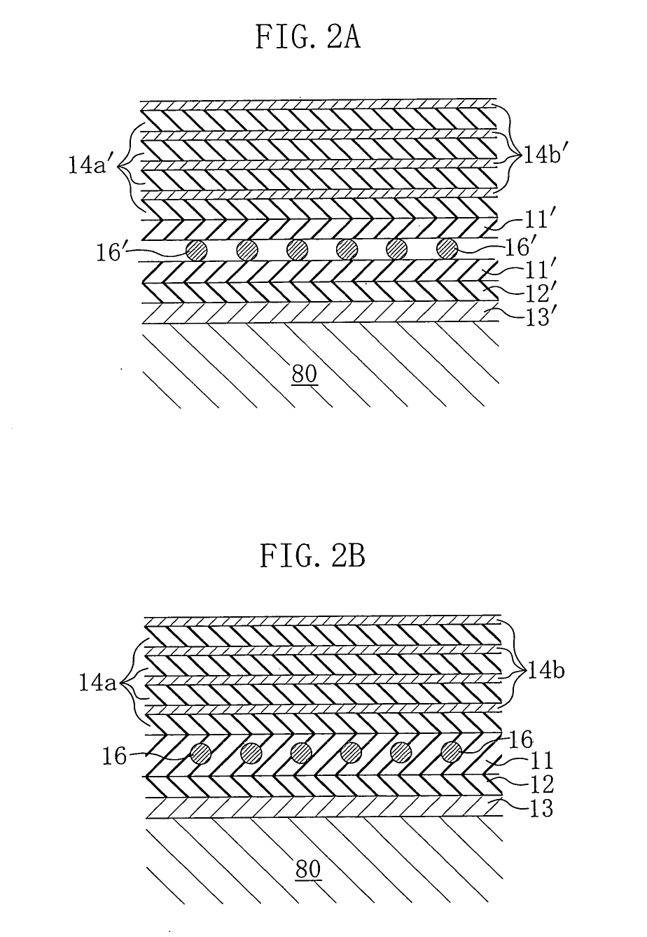

Next, a description will be made of a method for fabricating the V-ribbed belt B with reference to FIGS. 2A and 2B.

First, materials for the fabrication of a V-ribbed belt B are prepared as follows: a first unvulcanized rubber sheet 12′ for the formation of a tension rubber layer 12, two second unvulcanized rubber sheets 11′ for the formation of an adhesion rubber layer 11, a plurality of third unvulcanized rubber sheets 14a′ for the formation of rubber layers 14a in a ribbed rubber layer 14, a plurality of adhesion-treated (or non-adhesion-treated) non-woven fabric sheets 14b′ (of 0.02 mm to 1.50 mm thickness) for the formation of non-woven fabric layers 14b in the ribbed rubber layer 14, an adhesion-treated woven fabric 13′ for the formation of a back face reinforcing fabric 13, and an adhesion-treated twist yarn 16′ for the formation of a cord 16.

Next, the woven fabric 13′ formed in a cylinder is wrapped over the molding drum 80 to fit on it, the first unvulcanized rubber sheet 12′ is then wrapped around the woven fabric 13′ a predetermined number of times, and one of the second unvulcanized rubber sheets 11′ is then wrapped around a predetermined number of times.

Then, the twist yarn 16′ is wound around the second unvulcanized rubber sheet 11′ on the molding drum 80 to form helical turns at regular pitches from one end to the other end of the molding drum 80.

Thereafter, the other second unvulcanized rubber sheet 11′ is wrapped around the layer of the twist yam 16′ a predetermined number of times.

Next, one of the third unvulcanized rubber sheets 14a′ is wrapped around the second unvulcanized rubber sheet 11′ a predetermined number of times, and one of the non-woven fabric sheets 14b′ is then wrapped therearound. This alternate wrapping of a third unvulcanized rubber sheet 14a′ and a non-woven fabric sheet 14b′ is repeated a predetermined number of times (one to thirty times). As a result of the above process, as shown in FIG. 2A, a stack is formed on the outer periphery of the molding drum 80, and is as follows, in the order from nearest to farthest from the molding drum: the woven fabric 13′, the first unvulcanized rubber sheet 12′, the second unvulcanized rubber sheet 11′, the twist yarn 16′, the second unvulcanized rubber sheet 11′, and a layered structure of the third unvulcanized rubber sheets 14a′ and the non-woven fabric sheets 14b′ (FIG. 2A shows the case where four non-woven fabric sheets 14b′ are contained in the stack.

Next, the molding drum 80 wrapped with the stack is covered with a rubber sleeve, put into a vulcanizer, and cured therein under predetermined temperature and pressure conditions for a predetermined time. During the time, the first to third unvulcanized rubber sheets 11′, 12′ and 14a′ are fluidized and crosslinked so that the woven fabric 13′, the non-woven fabric sheets 14b′ and the twist yarn 16′ are bonded together with the rubber materials to form an integral cylindrical slab. As a result, as shown in FIG. 2B, a lamination is formed on the outer periphery of the molding drum 80 and is as follows, in the order from nearest to farthest from the molding drum: a back face reinforcing fabric 13, a tension rubber layer 12, an adhesion rubber layer 11 having a cord 16 embedded therein, and a ribbed rubber layer 14 in which rubber layers 14a and non-woven fabric layers 14b are alternately stacked.

Then, the molding drum 80 is taken out of the vulcanizer, the rubber sleeve is removed, and subsequently the molded slab is removed.

Next, the slab is cut into three or four axially even pieces, and the outer periphery of each piece is ground circumferentially to form ribs 15.

Finally, each slab piece is cut into specified widths, and each cut piece is turned over to direct its side having the ribs 15 inward, thereby obtaining a V-ribbed belt B.

In fabricating the above V-ribbed belt B, the layered structure of the non-woven fabric sheets and the third unvulcanized rubber sheets may be formed firstly by alternately stacking one or more third unvulcanized rubber sheets and one or more non-woven fabric sheets to organize them into an elongate sheet, and then by wrapping the elongate sheet around the second unvulcanized rubber sheet a predetermined number of times. The elongate sheet may consist of a double-layered structure of a third unvulcanized rubber sheet and a non-woven fabric sheet, or a triple-layered structure with a non-woven fabric sheet sandwiched between two third unvulcanized rubber sheets, or a multi-layered structure. In this connection, if a non-woven fabric sheet 14b′ before molded has a thickness of about 0.20 mm or less, the non-woven fabric layer 14b obtained by molding it has substantially the same thickness.

As described above, according to the fabrication method of a V-ribbed belt B of the present invention, a ribbed rubber layer 14 is formed by one or more third unvulcanized rubber sheets 14a′ and one or more non-woven fabric sheets 14b′. Therefore, there is no need to cut a short-fiber-containing unvulcanized rubber sheet in an appropriate length and align the orientation of short fibers with the belt widthwise direction, unlike the case of fabricating a friction drive belt in which the ribbed rubber layer 14 is made from short-fiber-containing rubber.

Next, a description will be made of a belt drive system 30 using the V-ribbed belt B.

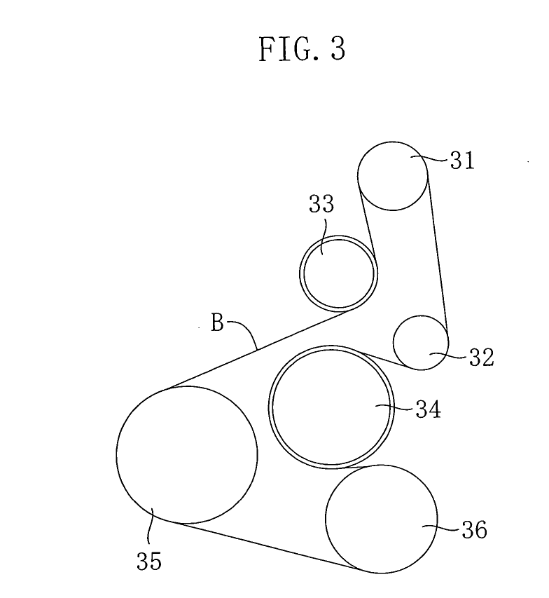

FIG. 3 shows a pulley layout of a serpentine belt drive system for automotive engine accessories, in which a V-ribbed belt B is wrapped around the pulleys.

This pulley layout for serpentine belt accessory drive is composed of an accessory A pulley 31 located at an uppermost position, an accessory B pulley 32 placed below the accessory A pulley 31, a tensioner pulley 33 placed to the lower left of the accessory A pulley 31, an accessory C pulley 34 placed below the tensioner pulley 33, a crankshaft pulley 35 placed to the lower left of the tensioner pulley 33, and an accessory D pulley 36 placed to the lower right of the crankshaft pulley 35. All the pulleys other than the tensioner pulley 33 and the accessory C pulley 34, which are both flat pulleys, are ribbed pulleys. The V-ribbed belt B is wrapped around the accessory A pulley 31 to make contact at its ribs 15, then wrapped around the tensioner pulley 33 to make contact at its belt back face, then sequentially wrapped around the crankshaft pulley 35 and the accessory D pulley 36 to make contact at its ribs 15, then wrapped around the accessory C pulley 34 to make contact at its belt back face, then wrapped around the accessory B pulley 32 to make contact at its ribs 15, and finally returned to the accessory A pulley 31. This V-ribbed pulley B is driven into clockwise rotation by the crankshaft pulley 35, thereby driving the accessory pulleys including the accessory A pulley 31.

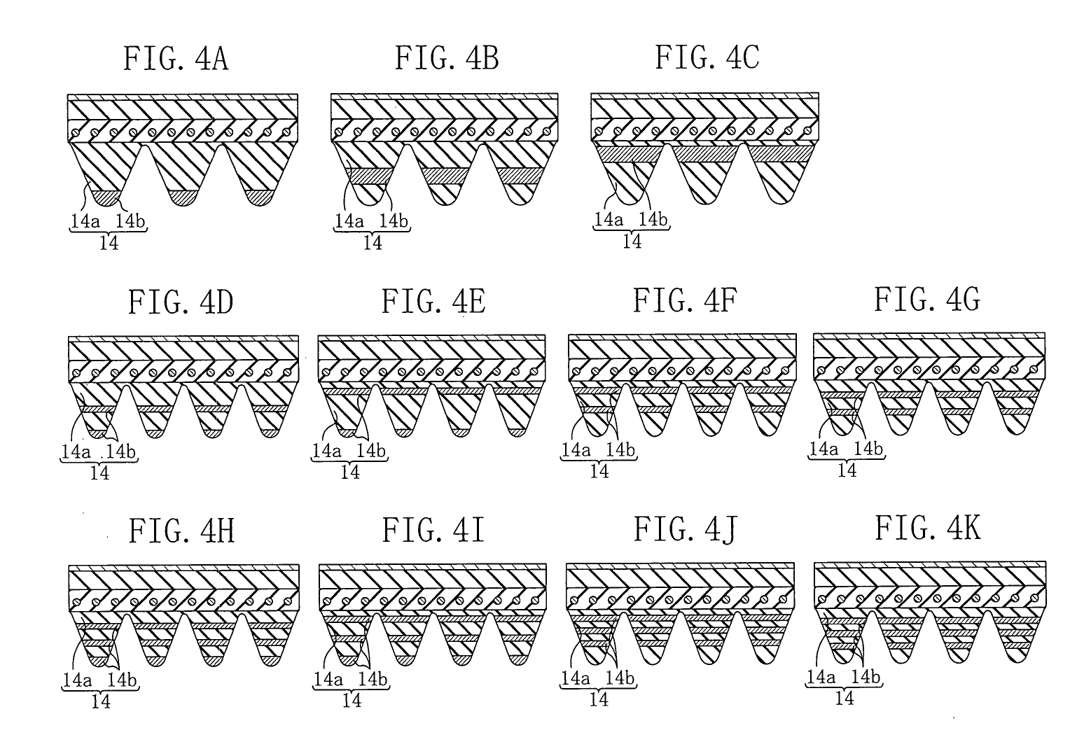

V-ribbed belts according to other embodiments of the present invention include those containing a single non-woven fabric layer 14b as shown in FIGS. 4A to 4C, those containing two non-woven fabric layers 14b as shown in FIGS. 4D to 4G, and those containing three or more non-woven fabric layers 14b as shown in FIGS. 4H to 4K. As described before, the shearing force acting on the belt is greater, in the ribbed rubber layer 14, toward the belt outer periphery than toward the belt inner periphery. If the proportion of non-woven fabric layers 14b contained in the ribbed rubber layer 14 is greater toward the belt outer periphery, the risk of delamination is increased. Therefore, the preference in this respect among the above V-ribbed belts is not for those in which a non-woven fabric layer 14b is disposed toward the rib roots as shown in FIGS. 4C, 4E, 4F, 4I and 4J, but for those in which a non-woven fabric layer 14b is disposed at the rib tops and rib mid-portions as shown in the other figures. Furthermore, since the traveling belt makes contact with a pulley beginning at the rib tops, a lower coefficient of friction at the rib tops leads to a greater suppression of occurrence of abnormal sounds during the belt travel. Therefore, the preference in this respect is not for V-ribbed belts in which a rubber layer 14a is disposed at the rib tops as shown in FIGS. 4B, 4C, 4F, 4G, 4J and 4K, but for those in which a non-woven fabric layer 14b is disposed at the rib tops as shown in the other figures. Considering both the respects together, V-ribbed belts as shown in FIGS. 4A, 4D and 4H are preferable.

Although the above embodiments are directed to V-ribbed belts, applicable belts for this invention are not limited to V-ribbed belts but include other types of friction drive belts such as V-belts.

### WORKING EXAMPLES

A description will be made of belt evaluations based on actually conducted tests.

(Belts for Test Evaluation)

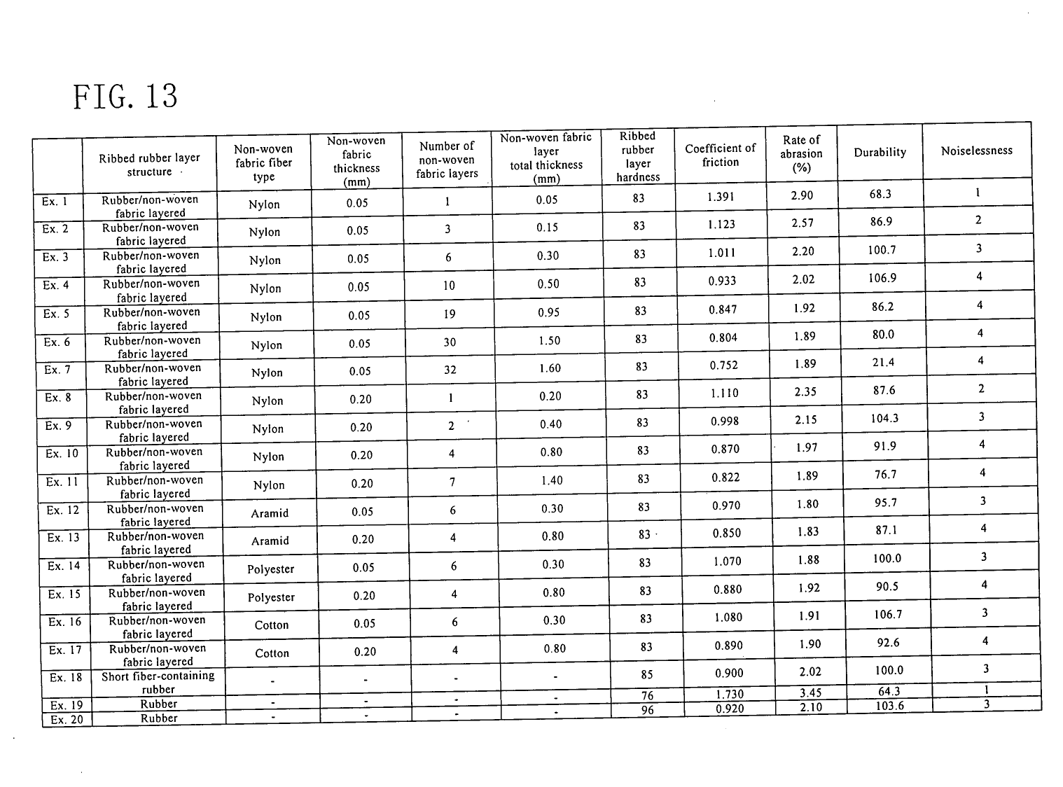

V-ribbed belts for test evaluation were prepared as below. The belt structures are also shown in FIG. 13.

### Example 1

Prepared as Example 1 was a V-ribbed belt (rib height: 2.00 mm) which has the same structure as in the first-mentioned embodiment and in which a single non-woven fabric layer was formed using a non-woven nylon fiber fabric sheet of 0.05 mm thickness subjected to adhesion treatment with resorcinol-formaldehyde latex (RFL) liquid and rubber cement. Chloroprene rubber (CR) was used as the rubber component of a rubber composition constituting each of the adhesion rubber layer, the tension rubber layer and the rubber layer of the ribbed rubber layer. The back face reinforcing fabric was formed using a woven nylon fiber fabric subjected to adhesion treatment with rubber cement. The cord was formed using a twist yarn (Z-twisted) of polyethylene terephthalate (PET) fibers subjected to adhesion treatment with resorcinol-formaldehyde latex (RFL) liquid and rubber cement and stretch thermoforming process.

### Example 2

Prepared as Example 2 was a V-ribbed belt which has the same structure as in Example 1 except that three non-woven fabric layers were formed using non-woven nylon fiber fabric sheets of 0.05 mm thickness each.

### Example 3

Prepared as Example 3 was a V-ribbed belt which has the same structure as in Example 1 except that six non-woven fabric layers were formed using non-woven nylon fiber fabric sheets of 0.05 mm thickness each.

### Example 4

Prepared as Example 4 was a V-ribbed belt which has the same structure as in Example 1 except that ten non-woven fabric layers were formed using non-woven nylon fiber fabric sheets of 0.05 mm thickness each.

### Example 5

Prepared as Example 5 was a V-ribbed belt which has the same structure as in Example 1 except that 19 non-woven fabric layers were formed using non-woven nylon fiber fabric sheets of 0.05 mm thickness each.

### Example 6

Prepared as Example 6 was a V-ribbed belt which has the same structure as in Example 1 except that 30 non-woven fabric layers were formed using non-woven nylon fiber fabric sheets of 0.05 mm thickness each.

### Example 7

Prepared as Example 7 was a V-ribbed belt which has the same structure as in Example 1 except that 32 non-woven fabric layers were formed using non-woven nylon fiber fabric sheets of 0.05 mm thickness each.

### Example 8

Prepared as Example 8 was a V-ribbed belt which has the same structure as in Example 1 except that a single non-woven fabric layer was formed using a non-woven nylon fiber fabric sheet of 0.20 mm thickness.

### Example 9

Prepared as Example 9 was a V-ribbed belt which has the same structure as in Example 1 except that two non-woven fabric layers were formed using non-woven nylon fiber fabric sheets of 0.20 mm thickness each.

### Example 10

Prepared as Example 10 was a V-ribbed belt which has the same structure as in Example 1 except that four non-woven fabric layers were formed using non-woven nylon fiber fabric sheets of 0.20 mm thickness each.

### Example 11

Prepared as Example 11 was a V-ribbed belt which has the same structure as in Example 1 except that seven non-woven fabric layers were formed using non-woven nylon fiber fabric sheets of 0.20 mm thickness each.

### Example 12

Prepared as Example 12 was a V-ribbed belt which has the same structure as in Example 1 except that six non-woven fabric layers were formed using non-woven aramid fiber fabric sheets of 0.05 mm thickness each.

### Example 13

Prepared as Example 13 was a V-ribbed belt which has the same structure as in Example 1 except that four non-woven fabric layers were formed using non-woven aramid fiber fabric sheets of 0.20 mm thickness each.

### Example 14

Prepared as Example 14 was a V-ribbed belt which has the same structure as in Example 1 except that six non-woven fabric layers were formed using non-woven polyester fiber fabric sheets of 0.05 mm thickness each.

### Example 15

Prepared as Example 15 was a V-ribbed belt which has the same structure as in Example 1 except that four non-woven fabric layers were formed using non-woven polyester fiber fabric sheets of 0.20 mm thickness each.

### Example 16

Prepared as Example 16 was a V-ribbed belt which has the same structure as in Example 1 except that six non-woven fabric layers were formed using non-woven cotton fabric sheets of 0.05 mm thickness each.

### Example 17

Prepared as Example 17 was a V-ribbed belt which has the same structure as in Example 1 except that four non-woven fabric layers were formed using non-woven cotton fabric sheets of 0.20 mm thickness each.

### Example 18

Prepared as Example 18 was a V-ribbed belt which has the same structure as in Example 1 except that a ribbed rubber layer was formed from aramid short fiber-containing rubber.

### Example 19

Prepared as Example 19 was a V-ribbed belt which has the same structure as in Example 1 except that a ribbed rubber layer was formed from a low-hardness rubber composition (containing no short fibers).

### Example 20

Prepared as Example 20 was a V-ribbed belt which has the same structure as in Example 1 except that a ribbed rubber layer was formed from a high-hardness rubber composition (containing no short fibers).

(Test Evaluation Method)

<Hardness of Ribbed Rubber Layer>

For each of the V-ribbed belts of Examples 1 to 20, the hardness of the ribbed rubber layer was measured using an A-type spring hardness tester specified in JIS K6301.

<Coefficient of Friction at Rib Surface>

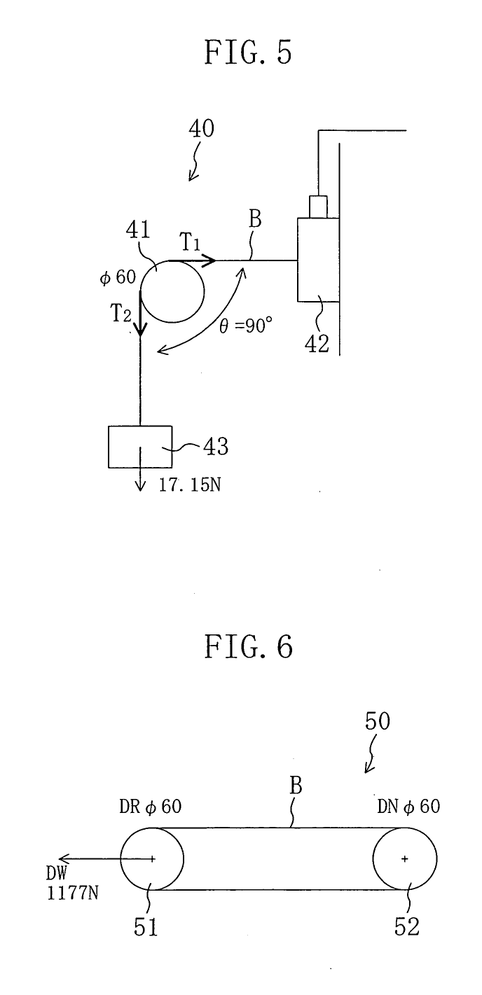

FIG. 5 shows a belt coefficient-of-friction measurement tester 40 used for measuring the coefficient of friction at the surface of the ribbed rubber layer. This belt coefficient-of-friction measurement tester 40 is composed of a ribbed pulley 41 of 60 mm diameter and a load cell 42 placed to the side of the ribbed pulley 41. The load cell 42 is arranged so that the later-described specimen is wrapped around it after being extended horizontally toward the ribbed pulley 41, i.e., so that the angle at which the specimen is wrapped around it is 90 degrees.

Strip-shaped specimens were produced from the V-ribbed belts of Examples 1 to 20. Each specimen was fixed at one end to the load cell 42 to direct its rib side downward, wrapped around the ribbed pulley 41 to make contact at its rib side, and then got down with a 1.75 kg weight 43 hung at the other end. Subsequently, the ribbed pulley 41 was rotated at 20 rpm in the direction of pulling up of the weight 43, and during the time, the tension T1 applied to the horizontal portion of the specimen between the load cell 42 and the ribbed pulley 41 was measured with the load cell 42. In this case, the tension T2 applied to the vertical portion of the specimen between the ribbed pulley 41 and the weight 43 is 17.15N corresponding to the weight 43. Then, the coefficient of friction was calculated according to the following formula:

$${μ}^{′} = \frac{ln \frac{{T}_{1}}{{T}_{2}}}{θ}$$

<Abrasion Rate of the Rib Surface>

FIG. 6 shows the layout of a belt run tester 50 for evaluating V-ribbed belts on an abrasion resistance test. This belt durability tester is composed of a pair of pulleys 51 and 52 of 60 mm diameter arranged to the right and left, wherein the left-side pulley is a drive pulley and the right-side pulley is a driven pulley.

After each of the V-ribbed belts of Examples 1 to 20 was measured in weight, it was subjected to a belt run test. In this test, each belt was wrapped around both the ribbed pulleys 51 and 52 to make contact at its rib side, the left-side ribbed pulley 51 which is a drive pulley was pulled sideward to impose a deadweight of 1177N thereon, a rotation load of 3.8 kW was applied to the right-side ribbed pulley 52 which is a driven pulley, the left-side ribbed pulley 51 was rotated at 3500 rpm for 24 hours under room temperature conditions. Then, each belt after 24 hours run was measured in weight, and its rate of abrasion was calculated according to the following formula:

$$Rate of abrasion = \frac{Initial weight - afterrun weight}{Initial weight} \times 100$$

<Running Durability>

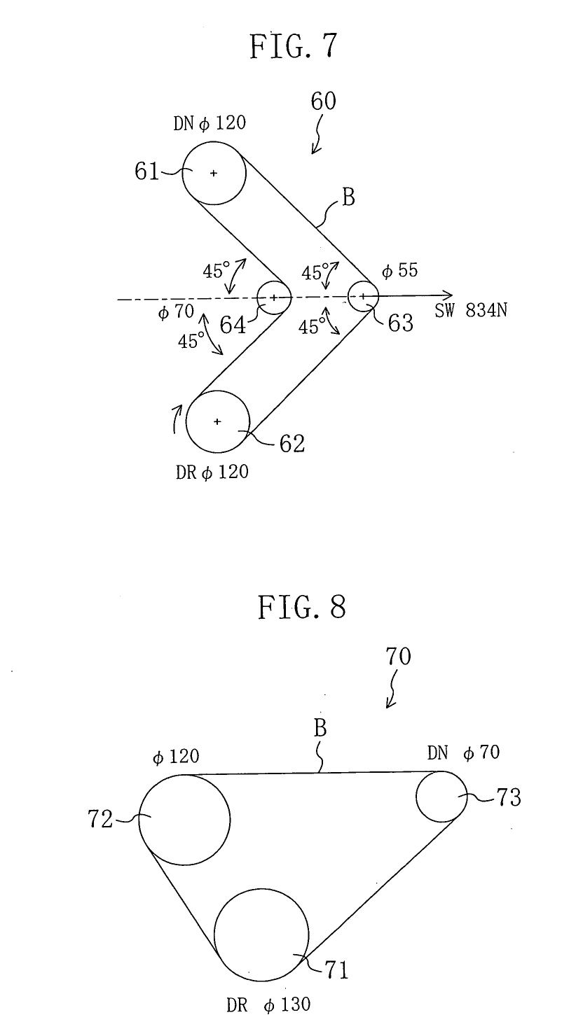

FIG. 7 shows the layout of a belt run tester 60 for durability evaluation on V-ribbed belts. This belt run tester 60 is composed of large-diameter ribbed pulleys 61 and 62 of 120 mm diameter disposed one above the other (the upper is a driven pulley and the lower is a drive pulley), an idler pulley 64 of 70 mm diameter placed to the right of and at a height intermediate the large-diameter ribbed pulleys, and a small-diameter ribbed pulley 63 of 45 mm pulley diameter disposed to the right of the idler pulley 64. The idler pulley 64 is positioned so that the angle at which the belt is wrapped around it is 90 degrees.

A belt run test was conducted on each of the V-ribbed belts of the above Examples 1 to 20. In the belt run test, each belt was wrapped around the three ribbed pulleys 61 to 63 to make contact at its rib side and wrapped around the idler pulley 64 to make contact at its back face, the small-diameter ribbed pulley 63 was pulled sideward to impose a set weight of 834N thereon, and the lower ribbed pulley 62, which is a drive pulley, was rotated at 4900 rpm in an atmosphere of 85° C.±3° C. The time from the start of the run until the occurrence of a crack was measured under these conditions, and the relative running durability was calculated with respect to the time data from Example 18 which is a reference value of 100.

<Noiselessness>

FIG. 8 shows the layout of a belt run tester 70 for noiselessness evaluation on V-ribbed belts. This belt run tester 70 is composed of a drive ribbed pulley 71 of 130 mm diameter, a larger driven ribbed pulley 72 of 120 mm diameter placed to the upper left of the drive ribbed pulley 71, and a smaller driven ribbed pulley 73 of 70 nm diameter placed to the upper right of the drive ribbed pulley 71.

A belt run test was conducted on each of the V-ribbed pulleys of Examples 1 to 20 by wrapping each belt around the three ribbed pulleys 71 to 73 to make contact at its rib side and rotating the drive ribbed pulley 71. The noise production of each belt at the smaller drive ribbed pulley 73 was sensorily evaluated at five levels.

(Test Evaluation Results)

The test results are shown in FIG. 13. In this case, Example 18 in which the ribbed rubber layer is made of short fiber-containing rubber can be considered as an example of conventional V-ribbed belts.

<Hardness of Ribbed Rubber Layer>

In each of Example 1 to 17 in which the ribbed rubber layer has a rubber/non-woven fabric layered structure, the ribbed rubber layer has a hardness of 83. This shows that the hardness of the ribbed rubber layer does not depend on the type and thickness of non-woven fabric and the total thickness of non-woven fabric layers. In Example 18 (conventional example) in which the ribbed rubber layer is made of a rubber composite, i.e., short fiber-containing rubber, the ribbed rubber layer has a hardness of 85, which is slightly higher than those of Examples 1 to 17. Examples 19 and 20 in which the ribbed rubber layer is made of rubber show the results on which respective hardnesses of their rubber compositions reflected.

<Coefficient of Friction at Ribbed Rubber Layer Surface>

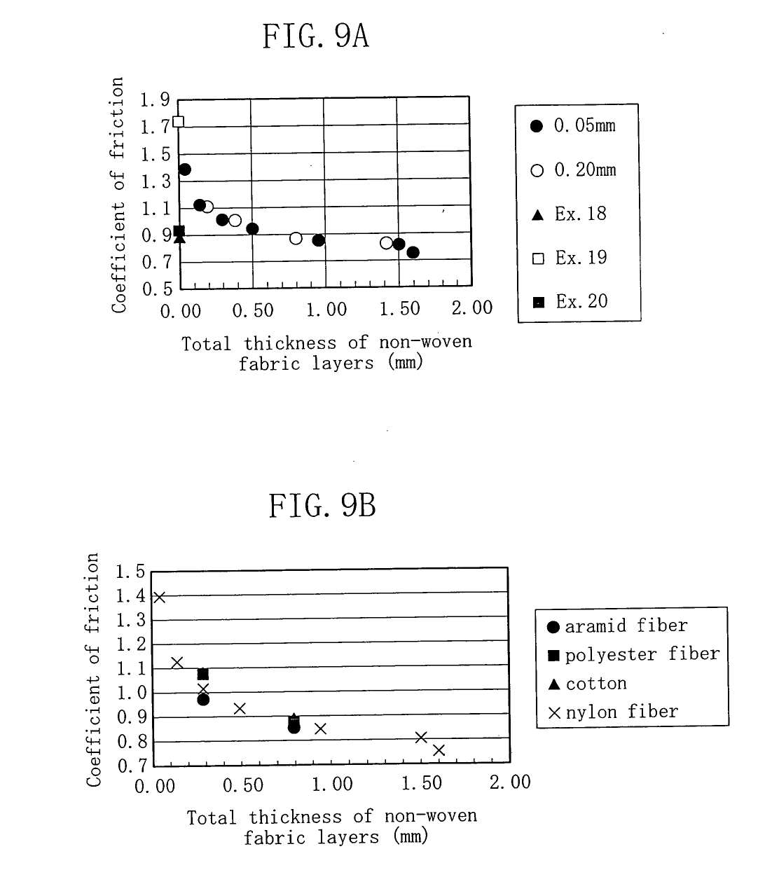

FIG. 9A shows the relation between the total thickness of non-woven fabric layers and the coefficient of friction at the ribbed rubber layer surface for Examples 1 to 11 using nylon fiber non-woven fabrics, and for comparison, also that for Examples 18 to 20.

Referring to FIG. 9A, it is shown that as the total thickness of the non-woven fabric layers is increased, the coefficient of friction is decreased. This is because the non-woven fabrics exposed at the surface of the ribbed rubber layer reduced the coefficient of friction. The effect of decreasing the coefficient of friction is outstanding for total thicknesses of non-woven fabric layers up to 0.5 mm (25% of the ribbed rubber layer thickness), but it is small for total thicknesses of non-woven fabric layers over 0.5 mm. Furthermore, as seen from Examples 1 to 7 having a non-woven fabric thickness of 0.05 mm and Examples 8 to 11 having a non-woven fabric thickness of 0.20 mm, the coefficient of friction is not affected by the thickness of each non-woven fabric, but given as an overall characteristic across the surface of the ribbed rubber layer by the total thickness of non-woven fabric layers. Example 18 (conventional example) in which the ribbed rubber layer is made of short fiber-containing rubber has a coefficient of friction of 0.900. In order to obtain an equivalent coefficient of friction, the total thickness of non-woven fabric layers needs to be 0.50 mm (25% of the ribbed rubber layer thickness) or more. Out of Examples 19 and 20 in which the ribbed rubber layer is made of rubber, Example 19 of low rubber hardness has a very high coefficient of friction, but Example 20 of high rubber hardness has an equivalent coefficient of friction to Example 18.

FIG. 9B shows the relation between the total thickness of non-woven fabric layers ant the coefficient of friction at the surface of the ribbed rubber layer for Examples 1 to 7 and 12 to 17.

Referring to FIG. 9B, it is shown that the coefficient of friction is not affected by which of nylon fibers, aramid fibers, polyester fibers and cotton is used for the non-woven fabric, i.e., the fiber type, but depends on the total thickness of non-woven fabric layers.

<Abrasion Rate of Ribbed Rubber Layer>

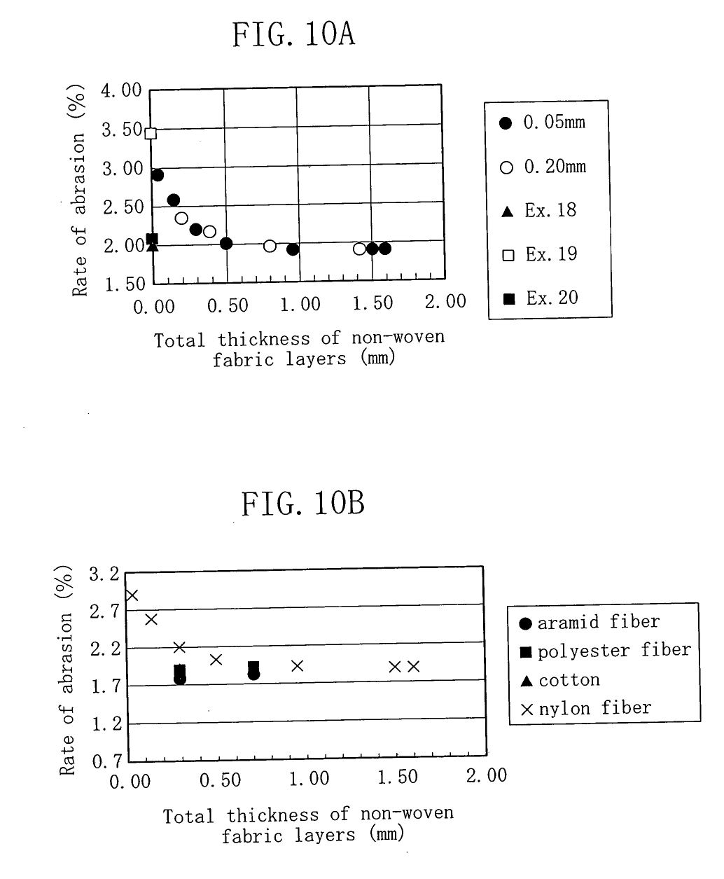

FIG. 10A shows the relation between the total thickness of non-woven fabric layers and the rate of abrasion of the ribbed rubber layer for Examples 1 to 11, and for comparison, also that for Examples 18 to 20. FIG. 10B shows the relation between the total thickness of non-woven fabric layers and the rate of abrasion of the ribbed rubber layer for Examples 1 to 7 and 12 to 17.

As seen from FIGS. 10A and 10B, the rate of abrasion is also given as an overall characteristic across the surface of the ribbed rubber layer like the coefficient of friction. Namely, there exists a correlation between the rate of abrasion and the coefficient of friction.

More specifically, reference to FIG. 10A shows that as the total thickness of the non-woven fabric layers is increased, the rate of abrasion is decreased. The effect of decreasing the rate of abrasion is outstanding for total thicknesses of non-woven fabric layers up to 0.5 mm (25% of the ribbed rubber layer thickness), but it is small for total thicknesses of non-woven fabric layers over 0.5 mm. Furthermore, as seen from Examples 1 to 7 having a non-woven fabric thickness of 0.05 mm and Examples 8 to 11 having a non-woven fabric thickness of 0.20 mm, the rate of abrasion is not affected by the thickness of each non-woven fabric, but given as an overall characteristic across the ribbed rubber layer by the total thickness of non-woven fabric layers. Example 18 (conventional example) in which the ribbed rubber layer is made of short fiber-containing rubber has a rate of abrasion of 2.02%. In order to obtain an equivalent rate of abrasion, the total thickness of non-woven fabric layers needs to be 0.50 mm (25% of the ribbed rubber layer thickness) or more. Out of Examples 19 and 20 in which the ribbed rubber layer is made of rubber, Example 19 of low rubber hardness has a very high rate of abrasion, but Example 20 of high rubber hardness has an equivalent rate of abrasion to Example 18. Moreover, it is seen from FIG. 10B that the rate of abrasion is not affected by which of nylon fibers, aramid fibers, polyester fibers and cotton is used for the non-woven fabric, i.e., the fiber type, but depends on the total thickness of non-woven fabric layers.

<Running Durability>

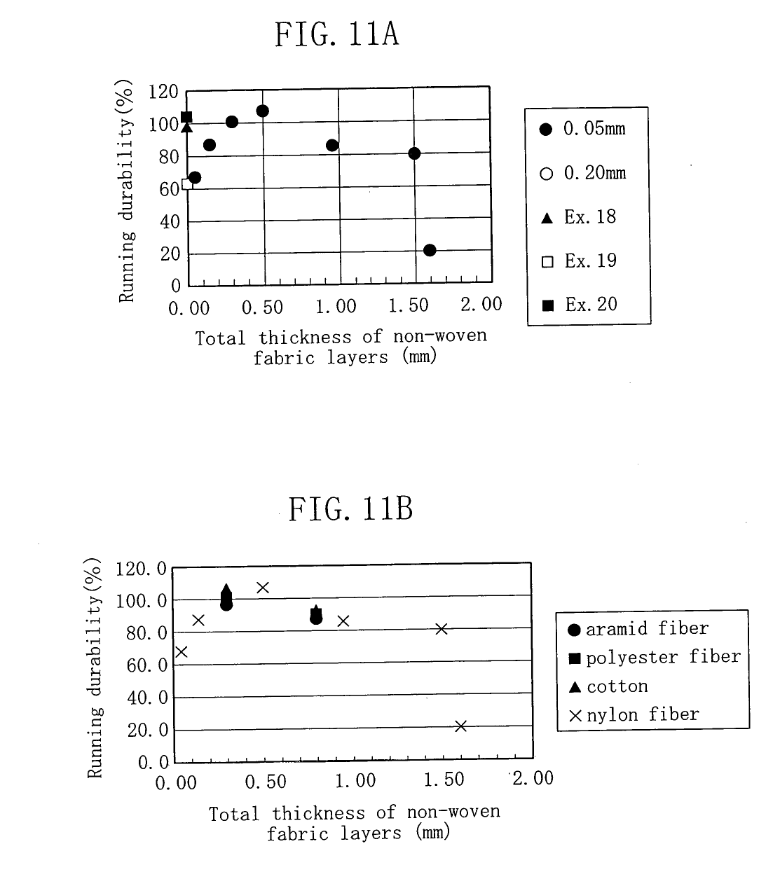

FIG. 11A shows the relation between the total thickness of non-woven fabric layers and the running durability of the relevant belt for Examples 1 to 11 using nylon fiber non-woven fabrics, and for comparison, also that for Examples 18 to 20.

Referring to FIG. 11A, it is shown that the running durability is improved with increasing total thickness of non-woven fabric layers up to 0.5 mm (25% of the ribbed rubber layer thickness), while on the other hand it is deteriorated with increasing total thickness of non-woven fabric layers over 0.5 mm. The running durability, in practice, needs to be 80 or more per cent of the running durability of Example 18 (conventional example), i.e., 80% or more, and therefore the total thickness of non-woven fabric layers needs to be at least 0.10 mm (5% of the ribbed rubber layer thickness) and at most 1.5 mm (75% of the ribbed rubber layer thickness). The running durability is preferably equal to or greater than that of Example 18, i.e., 100% or more, and in that case, the total thickness of non-woven fabric layers needs to be at least 0.3 mm (15% of the ribbed rubber layer thickness) and at most 0.7 mm (35% of the ribbed rubber layer thickness). Furthermore, as seen from Examples 1 to 7 having a non-woven fabric thickness of 0.05 mm and Examples 8 to 11 having a non-woven fabric thickness of 0.20 mm, the running durability is also not affected by the thickness of each non-woven fabric, but given as an overall characteristic across the ribbed rubber layer by the total thickness of non-woven fabric layers. Out of Examples 19 and 20 in which the ribbed rubber layer is made of rubber, Example 19 of low rubber hardness has a very low running durability, but Example 20 of high rubber hardness has an equivalent running durability to Example 18.

FIG. 11B shows the relation between the total thickness of non-woven fabric layers and the running durability of the relevant belt for Examples 1 to 7 and 12 to 17.

Referring to FIG. 11B, it is shown that the running durability is also not affected by which of nylon fibers, aramid fibers, polyester fibers and cotton is used for the non-woven fabric, i.e., the fiber type, but depends on the total thickness of non-woven fabric layers.

<Noiselessness>

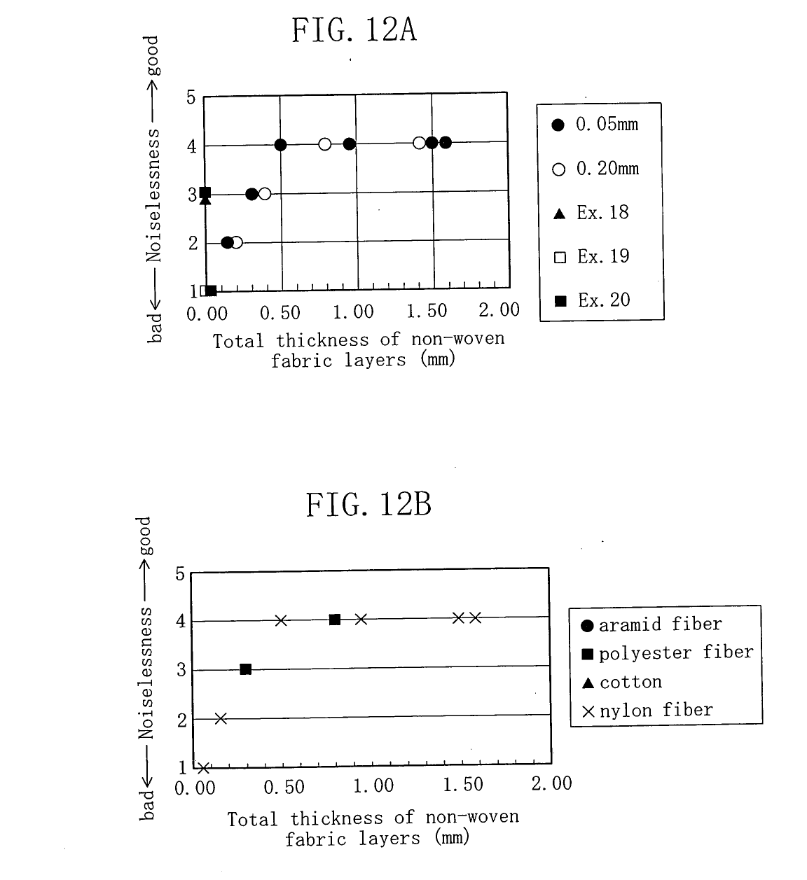

FIG. 12A shows the relation between the total thickness of non-woven fabric layers and the noiselessness of the relevant belt for Examples 1 to 11 using nylon fiber non-woven fabrics, and for comparison, also that for Examples 18 to 20.

Referring to FIG. 12A, it is shown that the noiselessness is improved, i.e., abnormal sounds are reduced, with increasing total thickness of non-woven fabric layers up to 0.5 mm (25% of the ribbed rubber layer thickness), but increase in the total thickness of non-woven fabric layers over 0.5 mm does not lead to further improved noiselessness. Furthermore, as seen from Examples 1 to 7 having a non-woven fabric thickness of 0.05 mm and Examples 8 to 11 having a non-woven fabric thickness of 0.20 mm, the noiselessness is not affected by the thickness of each non-woven fabric, but given as an overall characteristic across the ribbed rubber layer by the total thickness of non-woven fabric layers. Example 18 (conventional example) in which the ribbed rubber layer is made of short fiber-containing rubber has a noiselessness level of 3. In order to obtain an equivalent noiselessness level, the total thickness of non-woven fabric layers needs to be 0.30 mm (15% of the ribbed rubber layer thickness) or more. Out of Examples 19 and 20 in which the ribbed rubber layer is made of rubber, Example 19 of low rubber hardness has a very poor noiselessness, but Example 20 of high rubber hardness has an equivalent noiselessness to Example 18.

FIG. 12B shows the relation between the total thickness of non-woven fabric layers and the noiselessness of the relevant belt for Examples 1 to 7 and 12 to 17.

Referring to FIG. 12B, it is shown that the noiselessness is also not affected by which of nylon fibers, aramid fibers, polyester fibers and cotton is used for the non-woven fabric, i.e., the fiber type, but depends on the total thickness of non-woven fabric layers.

The foregoing discloses and describes merely exemplary embodiments of the present invention. One skilled in the art will readily recognize, from such discussion and accompanying drawings and claims, that various changes, modifications and variations can be made therein without departing from the spirit and scope of the present invention.

1. A friction drive belt, used by being wrapped around a plurality of pulleys, for transmitting power by friction between its belt body and each of the pulleys,
wherein a working part of the belt body through which power is transmitted has a structure in which one or more rubber layers (14a) and one or more non-woven fabric layers (14b) are alternately stacked along the thickness of the belt.

2. The friction drive belt of claim 1, wherein the belt body is the belt body of a V-ribbed belt.

3. The friction drive belt of claim 1, wherein the non-woven fabric layer or layers (14b) of the working part have a total thickness of 15% to 75%, both inclusive, of the thickness of the working part.

4. A method for fabricating a friction drive belt used by being wrapped around a plurality of pulleys, the method comprising the steps of:
forming, on the outer periphery of a molding drum, a structure in which one or more unvulcanized rubber layers (14a′) and one or more non-woven fabric layers (14b′) are alternately stacked to cover the whole circumference of the molding drum; and
applying heat and pressure to the layered structure of the unvulcanized rubber layer or layers (14a′) and the non-woven fabric layer or layers (14b′) to provide an integral lamination.
